(19) United States
(12) Patent Application Publication
(10) Pub. No.: US 2011/0306297 A1
(43) Pub. Date: Dec. 15, 2011

(54) Antenna Control

(76) Inventors: Han-Kuang Chang, Taipei (TW); Leo J. Gerten, Taipei (TW); Nanci A. Olson, The Woodlands, TX (US); Roy J. Finney, III, Houston, TX (US); Robin D. Svarvari, Houston, TX (US)

(21) Appl. No.: 13/202,305

(22) PCT Filed: Apr. 30, 2009
(86) PCT No.: PCT/US2009/042433

§ 371 Date: Aug. 18, 2011

(51) Int. Cl. H04B 7/00; H04B 1/00

(52) U.S. Cl. 455/41.2; 455/63.1

(57) ABSTRACT

In at least some embodiments, a computer system includes a first wireless technology (FWT) module and a second wireless technology (SWT) module. The computer system also comprises control logic coupled to the FWT module and the SWT module. The control logic determines if the FWT and SWT modules are both turned on and, if so, disables at least one SWT antenna based on its proximity to a FWT antenna being less than a predetermined distance while enabling at least one other FWT antenna.

### BACKGROUND

Modern electrical devices (e.g., notebook computers) sometimes have multiple and different wireless technologies built-in, where each wireless technology is associated with one or more antennas. For example, in a notebook computer, various wireless technology antennas are mounted around the display frame. There are ongoing efforts to develop co-existence strategies for different wireless technologies and to comply with government regulations. One such government regulation limits the specific absorption rate (SAR) of various consumer electronics to predetermined levels.

### BRIEF DESCRIPTION OF THE DRAWINGS

For a detailed description of exemplary embodiments of the invention, reference will now be made to the accompanying drawings in which:

FIG. 1 shows an electronic device in accordance with an embodiment of the disclosure;

FIG. 2 shows a computer system in accordance with an embodiment of the disclosure;

FIG. 3 shows a routine to enable or disable an antenna in accordance with an embodiment of the disclosure; and

FIG. 4 shows a method in accordance with an embodiment of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the disclosure are directed to electronic devices having multiple wireless technologies (WTs). To enable co-existence of multiple WTs and to simultaneously comply with government regulations, specific absorption rate (SAR) levels or other regulated parameters are maintained within predetermined levels. For example, in some embodiments, if first wireless technology (FWT) and second wireless technology (SWT) modules are both turned on, at least one SWT antenna within a predetermined proximity to a FWT antenna is disabled while at least one SWT antenna not within the predetermined proximity to the FWT antenna is enabled. In this manner, SAR levels are maintained within predetermined levels while enabling simultaneous transmission by FWT and SWT antennas. In accordance with some embodiments, the predetermined SAR levels are selected to avoid government testing that would otherwise be required for co-existing (co-transmitting) WTs.

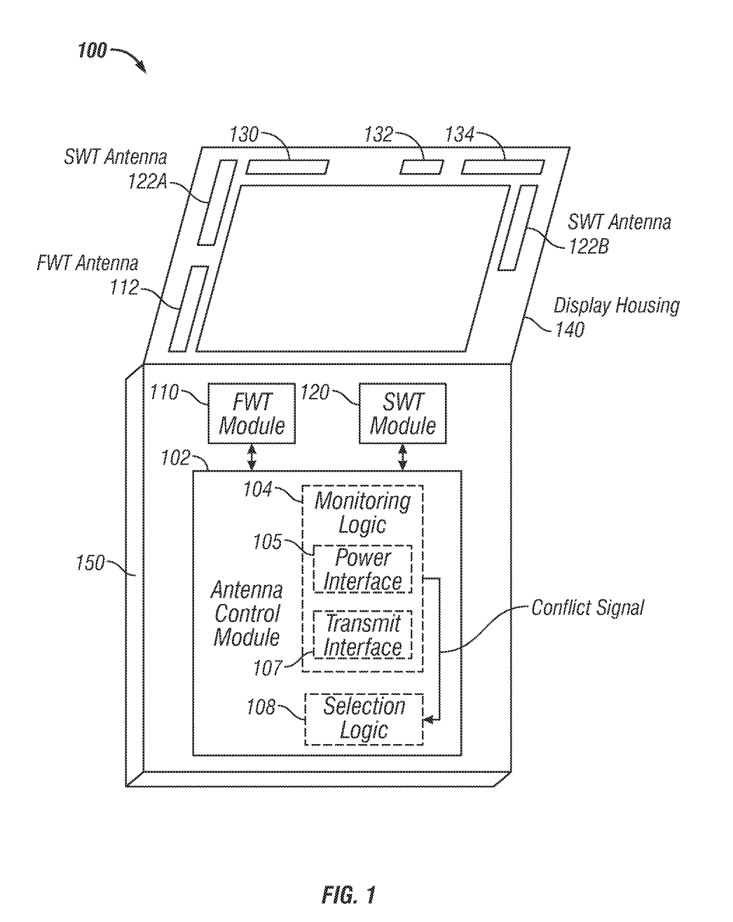

FIG. 1 shows an electronic device 100 in accordance with an embodiment of the disclosure. In some embodiments, the electronic device 100 corresponds to a portable computer. As shown, the electronic device 100 comprises an FWT module 110 and a SWT module 120 associated with different WTs. The FWT module 110 is associated with at least one FWT antenna 112 and the SWT module 120 is associated with at least two SWT antennas 122A, 122B. In at least some embodiments, the FWT module 110 and the SWT module 120 correspond to transceivers. The electronic device 100 also may include other antennas (e.g., antennas 130, 132 and 134), which correspond to another WT or multiple WTs. Without limitation to other embodiments, the FWT module 110 and the FWT antenna 112 operate based on a Wireless Local Area Network (WLAN) protocol. Meanwhile, the SWT module 120 and the SWT antennas 122A, 122B operate based on a Wireless Wide Area Network (WWAN) protocol. The antennas 130 and 134 may correspond to other wireless protocols such as WLAN 2 (e.g., 802.11n). The antenna 132 may correspond to a global positioning system (GPS) protocol. Other antennas (not shown) may additionally or alternatively be provided for Bluetooth, Ultra Wideband (UWB), mobile television, or other wireless protocols.

In the example of FIG. 1, the various antennas (112, 122A, 122B, 130, 132, 134) are contained around the perimeter of a display housing 140 (e.g., a liquid-crystal display housing) for the electronic device 100. The display housing 140 may be coupled to a main chassis 150 of the electronic device 100 using hinges that enable positioning the display housing 140 as desired. In alternative embodiments, some of these antennas may be housed around the perimeter of the display housing 140 while others are contained in the main chassis 150 of the electronic device 100. In alternative embodiments, some of these antennas may be external to the electronic device 100 and plugged into a port of the electronic device 100. In alternative embodiments, the display 140 may be built into the main chassis 150. In such embodiments, the various antennas may be housed, for example, around the perimeter of the main chassis 150 or may be external to the electronic device 100.

As shown in FIG. 1, the electronic device 100 also comprises an antenna control module 102 coupled to the FWT module 110 and the SWT module 120. The antenna control module 102 has control logic referred to in FIG. 1 as monitoring logic 104 and selection logic 108. In accordance with at least some embodiments, the monitoring logic 104 comprises a power interface 105 to monitor a power state of the FWT module 110 and the SWT module 120. If the power interface 105 determines that both the FWT module 110 and the SWT module 120 are turned on, the monitoring logic 104 provides a “conflict” signal to the selection logic 108. Upon receiving the conflict signal, the selection logic 108 may cause, for example, the SWT antenna 122A to be disabled and the SWT antenna 122B to be enabled. As used herein, the term “disabled antenna” refers to preventing transmissions generated within a WT module from reaching an antenna (e.g., controlling a switch) and/or configuring a WT module to not generate transmissions for an antenna (updating WT module operations). In FIG. 1, the SWT antenna 122A is selected to be disabled due to its proximity to the FWT antenna 112, which is also enabled. In accordance with some embodiments, all SWT antennas within a predetermined range (e.g., alternatively 5 cm or 10 cm) of any FWT antennas are disabled when the conflict signal is asserted. If the monitoring logic 104 subsequently determines that there is no conflict (e.g., the power interface 105 detects that the FWT module 110 is turned off), then the monitoring logic 104 de-asserts the conflict signal and the selection logic 108 enables all previously disabled antennas (e.g., the SWT antenna 122A). As used herein, the term “enabled antenna” refers to permitting transmissions generated within a WT module to reach an antenna (e.g., controlling a switch) and/or configuring a WT module to generate transmissions for an antenna (updating WT module operations).

In accordance with at least some embodiments, the power interface 105 determines the power state of the FWT module 110 and the SWT module 120 by monitoring a voltage level for each of the modules or module components. Alternatively, the power interface 105 determines the power state of the FWT module 110 and the SWT module 120 by querying another component that tracks and stores information regarding the power state of the FWT module 110 and the SWT module 120. For example, the FWT module 110 and the SWT module 120 may be powered on and off based on commands from a user or automated commands from hardware (or a hardware/software combination) that manages co-existence of the FWT module 110 and the SWT module 120. In either case, the power interface 105 is able to receive such commands or notification of such commands so as to track the power states of the FWT module 110 and the SWT module 120.

Additionally or alternatively, the monitoring logic 104 has a transmit interface 107 to monitor a transmit state of the FWT module 110 and the SWT module 120. If the transmit interface 107 determines that both the FWT module 110 and the SWT module 120 are transmitting data or are about to transmit data, the monitoring logic 104 provides a conflict signal to the selection logic 108. Upon receiving the conflict signal, the selection logic 108 causes, for example, the SWT antenna 122A to be disabled while the SWT antenna 122B and the FWT antenna 112 are enabled. Again, the SWT antenna 122A is selected to be disabled due to its proximity to the FWT antenna 112. If the monitoring logic 104 subsequently determines that there is no conflict (e.g., the transmit interface 107 detects that the FWT module 110 is not transmitting), then the monitoring logic 104 de-asserts the conflict signal and the selection logic 108 enables all previously disabled antennas (e.g., the SWT antenna 122A).

In accordance with at least some embodiments, the monitoring logic 104 determines the transmit state of the FWT module 110 and the SWT module 120 by first determining the power state as described previously. In other words, the transmit interface 107 assumes there is no transmission if a module is turned off. If the transmit interface 107 determines that both the FWT module 110 and the SWT module 120 are turned on, the transmit interface 107 proceeds to monitor at least one process for each module to detect when data is being transmitted or is about to be transmitted. As an example, one or more physical (PHY) layer processes or Media Access Control (MAC) processes may be monitored to identify data transmissions or pending data transmissions. In at least some embodiments, signals from the PHY layer or the MAC layer are provided to the transmit interface 107 to enable the transmit interface 107 to explicitly or implicitly detect data transmissions or pending data transmissions. In alternative embodiments, the transmit interface 107 is part of the PHY layer or MAC layer and thus has access to such information. In either case, the transmit interface 107 is configured to track the transmit states of the FWT module 110 and the SWT module 120, whereby the monitoring logic 104 asserts and de-asserts the conflict signal accordingly. In accordance with at least some embodiments, disabling or disconnecting the antenna 122A as described above, maintains SAR levels for the electronic device 100 within a predetermined range even during simultaneous transmissions by the FWT module 110 and the SWT module 120.

The process of monitoring the power state and/or the transmit state of the FWT module 110 and the SWT module 120 and selecting antennas to enable/disable can be repeated as desired. In alternative embodiments, a different pair of WT modules may be monitored and their antennas controlled (not just the FWT module 110 and the SWT module 120). Further, in some embodiments, more than two WT modules (e.g., 3 or 4) may be monitored simultaneously and their antennas enabled/disabled accordingly. In such embodiments, the selection logic 108 may operate to maintain at least one antenna operational for each WT module that is powered or transmitting, but disables selected antennas to spread out the transmission energy so as to maintain SAR levels within a predetermined range. If necessary to maintain SAR levels within the predetermined range, the selection logic 108 may at least temporarily disable all antennas of a particular WT module.

Although FIG. 1 illustrates various WTs having 1 or 2 antennas, it should be understood that the same WTs may have additional antennas. For example, a backup antenna or an alternate antenna (to change TX/RX performance) may be provided for various WTs. Additionally, simultaneous operation of multiple antennas (MIMO) may be supported by various WTs. When the antenna control module 102 disables/enables one or more antennas of a given protocol, it should be understood that the electronic device 102 may need to re-establish or otherwise adjusts a wireless connection. As an example, upon determining that an antenna has been disabled, a given MIMO WT module may throttle to 2×3 MIMO operations. In such case, there is a protocol change in conjunction with disabling an antenna. In other words, MIMO (i.e., 802.11n or other future HSPA+WWAN protocols) protocols vary depending on the quantity of antennas and corresponding receivers used. In some embodiments, MIMO WT modules are able to scale to different antenna usage as needed to extend battery life when maintaining a high data rate is not critical. In such case, one receiver and one corresponding antenna may be turned off based on an “extend battery life control signal” and the change in the protocol/mode is communicated to the other side of the link. A similar process can additionally or alternatively be implemented by MIMO WT modules when an antenna is disabled to reduce the combined radio field strength of different WT transmissions. For non-MIMO WT modules, antenna use/choice is independent of protocol/mode. Thus, non-MIMO WT modules may maintain the same protocol/mode when switching between different antennas (e.g., to reduce the combined radio field strength of different WT transmissions).

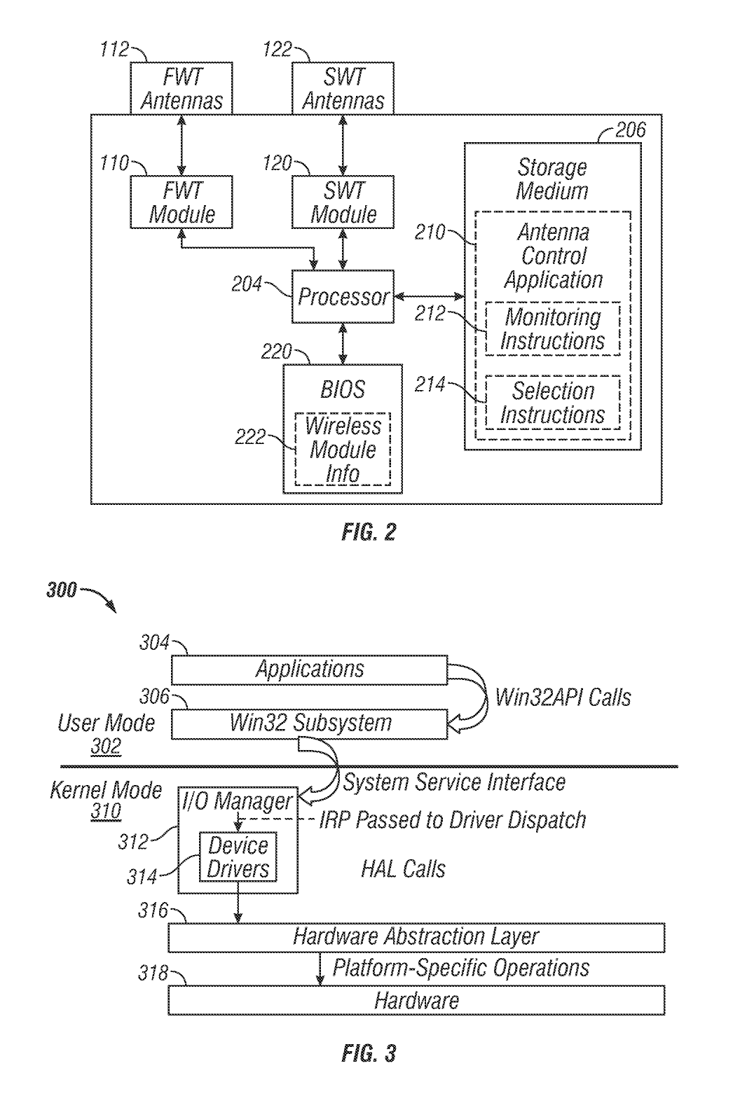

FIG. 2 shows a computer system 200 in accordance with an embodiment of the disclosure. The computer system 200 may be representative of, for example, a laptop computer, a netbook, or another mobile device with various wireless technologies. As shown, the computer system 200 comprises a processor 204 coupled to a storage medium 206. The storage medium 206 comprises, for example, volatile storage (e.g., RAM), non-volatile storage (e.g., a hard drive, flash memory, an optical disk), or a combination thereof. In operation, the computer system 200 performs various functions by providing instructions/data to the processor 204. In part, these instructions/data are stored in the storage medium 206 and are accessible for execution by the processor 204. For example, in accordance with some embodiments, the storage medium 206 comprises an antenna control application 210 that, when executed by the processor 204, selectively enables and disables antennas associated with at least one of the WT modules. More specifically, if the FWT and SWT modules 110 and 120 are both operative, the antenna control application 210 may disable any SWT antennas 122 that are less than a threshold distance from any FWT antennas 112. The storage medium 206 also may comprise other applications. For example, some of these applications, when executed by the processor 204, may generate data to be transmitted by one or more WT modules of the computer system 200. Additionally or alternatively, some of these applications, when executed by the processor, perform functions based on wireless data received by one or more WT modules of the computer system 200.

In the embodiment of FIG. 2, the FWT module 110 and the SWT module 120 described for FIG. 1 also couple to the processor 204. In accordance with some embodiments, the processor 204 and the storage medium 206 provide the antenna control module operations described for FIG. 1. In various embodiments, different and/or additional WT modules (besides FWT module 110 and SWT module 120) may be implemented with the computer system 200. The processor 204 also couples to a Basic Input/Output System (BIOS) 220, which stores wireless module information 222 as well as information related to other components of the computer system 200.

In accordance with at least some embodiments, the antenna control application 210 comprises control instructions referred to in FIG. 2 as monitoring instructions 212 and selection instructions 214. When executed, the monitoring instructions 212 cause the processor 204 to monitor a power state of the FWT module 110 and the SWT module 120. If the processor 204 determines that both the FWT module 110 and the SWT module 120 are turned on, the monitoring instructions 212 set a “conflict” flag or “conflict” bit(s) (hereinafter referred to simply as a conflict flag for convenience) to indicate there is a conflict between the FWT module 110 and the SWT module 120. The conflict flag may be stored in a predetermined register location or memory location. If the processor 204 determines that both the FWT module 110 and the SWT module 120 are not turned on (e.g., one of the modules is turned off), the monitoring instructions 212 cause the processor 204 to clear the conflict flag to indicate there is no conflict between the FWT module 110 and the SWT module 120 (or a previous conflict no longer exists).

In accordance with at least some embodiments, the monitoring instructions 212 cause the processor 204 to determine the power state of the FWT module 110 and the SWT module 120 by checking the wireless module information 222 stored by the BIOS 220. In other words, the wireless module information 222 includes explicit or implicit information regarding the power state of the modules. Alternatively, the monitoring instructions 212 cause the processor 204 to query another component that tracks and stores information regarding the power state of the FWT module 110 and the SWT module 120. In various embodiments, the power states of the FWT module 110 and the SWT module 120 may vary over time based on commands from a user or automated commands from hardware (or a hardware/software combination) that manages co-existence of the FWT module 110, the SWT module 120 and/or other WT modules. In either case, the monitoring instructions 212 cause the processor 204 to track the power states of the FWT module 110 and the SWT module 120 and to set/clear the conflict flag accordingly.

When executed, the selection instructions 214 cause the processor 204 to check the status of the conflict flag. If a conflict is indicated, the selection instructions 214 cause the processor 204 to perform a conflict routine that disables one or more antennas. For example, in some embodiments, the conflict routine enables the processor 204 to disable a first SWT antenna 122 while at least a second SWT antenna 122 is still enabled. The disabled SWT antenna 122 is selected, for example, based on prior knowledge regarding its proximity (distance) to at least one FWT antenna 112. As an example, any SWT antennas 122 within a predetermined range (e.g., approximately 5 cm) of any FWT antennas 112 may be disabled. If the processor 204 subsequently checks the status of the conflict flag and it has been cleared (e.g., based on ongoing or periodic execution of the monitoring instructions 212), the processor 204 may perform a restore routine to enable a previously disabled antenna. As will later be described, FIG. 3 shows a routine to disable (a conflict routine) or enable (a restore routine) an antenna.

In alternative embodiments, the monitoring instructions 212 cause the processor 204 to monitor a transmit state of the FWT module 110 and the SWT module 120. If the processor 204 determines that both the FWT module 110 and the SWT module 120 are transmitting data or are about to transmit data, the monitoring instructions 212 cause the processor 204 to set the conflict flag to indicate there is a conflict between the FWT module 110 and the SWT module 120. If the processor 204 determines that one or both of the FWT module 110 and the SWT module 120 are not turned on (e.g., one or both of the modules is turned off), the monitoring instructions 212 cause the processor 204 to clear the conflict flag to indicate there is no conflict between the FWT module 110 and the SWT module 120 (or a previous conflict no longer exists).

In accordance with at least some embodiments, the monitoring instructions 212 cause the processor 204 to determine the transmit state of the FWT module 110 and the SWT module 120 by querying the FWT module 110 and the SWT module 120 for information that explicitly or implicitly indicates a transmission is occurring or will occur. Alternatively, the monitoring instructions 212 cause the processor 204 to query another component that tracks and stores information regarding the transmit state of the FWT module 110 and the SWT module 120. In various embodiments, the transmit states of the FWT module 110 and the SWT module 120 may vary over time based on commands from a user or based on automated commands from hardware (or a hardware/software combination) that manages transmissions for each of the FWT module 110, the SWT module 120, and/or other WT modules of the computer system 200. In accordance with at least some embodiments, the monitoring instructions 212 cause the processor 204 to continuously track the transmit states of the FWT module 110 and the SWT module 120 and to set/clear the conflict flag accordingly. If the conflict flag is set, the selection instructions 214 cause the processor 204 perform a conflict routine to disable at least one previously enabled antenna. If the conflict flag is cleared, the selection instructions 214 cause the processor 204 perform a restore routine to enable at least one previously disabled antenna.

FIG. 3 shows a routine 300 to enable or disable an antenna in accordance with an embodiment of the disclosure. As shown, the routine 300 comprises user mode operations 302 and kernel mode operations 310. The user mode operations 302 comprise execution of an application 304 (e.g., the antenna control application 210). Upon detection of a trigger event (e.g., the conflict flag being set or cleared), the application 304 performs an Application Programming Interface (API) call (e.g., a Win32 API call) to a subsystem 306 (e.g., a Win32 subsystem) that handles API calls. The subsystem 306 then performs a System Service Interface (SSI) operation to notify a kernel mode input/output (I/O) manager 312 regarding a request to enable or disable at least one antenna. The kernel mode I/O manager 312 stores or has access to device drivers 314 including antenna device drivers. Various kernel mode operations 310 are then performed. For example, in at least some embodiments, I/O request packets (IRPs) are used to dispatch the needed drivers, which are able to access a Hardware Abstraction Layer (HAL) 316 via HAL calls. Finally, the HAL 316 is able to enable or disable hardware 318 (e.g., antennas switches or WT module operations) based on platform-specific operations. Without limitation to other embodiments, the routine 300 represents one illustrative technique to enable/disable antennas in a computer system with a Windows operating system (OS). Alternative routines may, for example, enable/disable antennas without relying on an OS or may rely on techniques supported by an alternative OS.

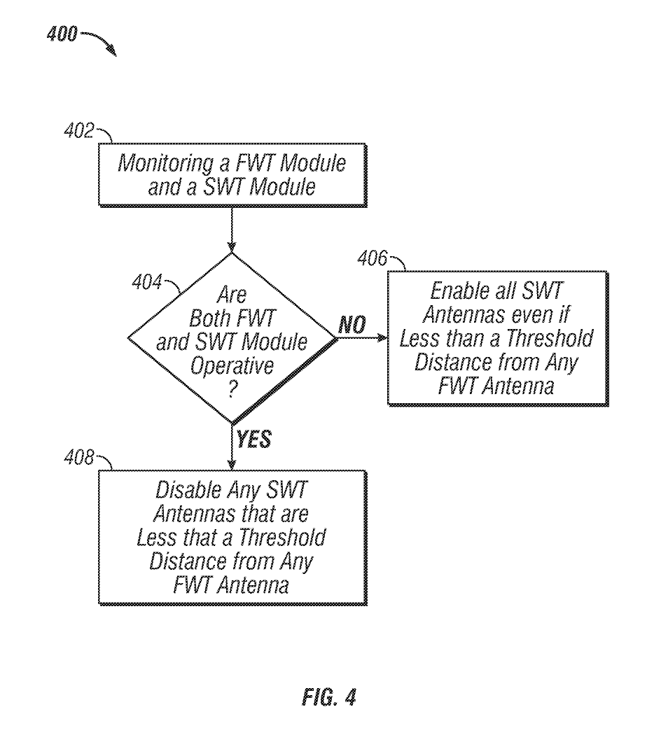

FIG. 4 shows a method 400 in accordance with an embodiment of the disclosure. As shown, the method 400 comprises monitoring a FWT module and a SWT module (block 402). If both the FWT and SWT modules are operative (determination block 404), any SWT antennas that are less than a threshold distance from any FWT antennas are disabled (block 408). If both of the FWT and SWT modules are not operative (determination block 404), all SWT antennas are enabled even if they are less than a threshold distance from any FWT antennas (block 406).

The method 400 may additionally or alternatively comprise other steps. For example, in at least some embodiments, disabling any SWT antennas may comprise triggering a System Service Interface (SSI) request that accesses drivers for SWT antennas that are to be disabled. Further, the method 400 may comprise monitoring a power state of the FWT and SWT modules to determine if the FWT and SWT modules are operative. Further, the method 400 may comprise monitoring a transmit state of the FWT and SWT modules to determine if the FWT and SWT modules are operative.

In at least some embodiments, the method 400 enables SAR levels to be maintained within predetermined levels while enabling simultaneous transmission by FWT and SWT antennas. The predetermined SAR levels may be selected, for example, to avoid government testing that would otherwise be required for co-existing (co-transmitting) WTs.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An electronic device with antenna control, comprising:
a first wireless technology (FWT) module;
a second wireless technology (SWT) module; and
control logic coupled to the FWT module and the SWT module, wherein the control logic determines if the FWT and SWT modules are both turned on and, if so, disables at least one SWT antenna based on its proximity to a FWT antenna being less than a predetermined distance while enabling at least one other FWT antenna.

2. The electronic device of claim 1 wherein the predetermined distance is approximately 5 cm.

3. The electronic device of claim 1 wherein the control logic comprises a power interface configured to monitor a power state for the FWT and SWT modules and to assert a conflict signal if the FWT and SWT modules are both turned on.

4. The electronic device of claim 1 wherein the control logic comprises a processor and a storage medium coupled to the processor, wherein the memory stores an antenna control application that, when executed, monitors a power state for the FWT and SWT modules and initiates a conflict routine if the FWT and SWT modules are both turned on.

5. The electronic device of claim 4 wherein the conflict routine disables the at least one SWT antenna by triggering a System Service Interface (SSI) request that accesses a driver for the at least one SWT antenna.

6. The electronic device of claim 1 wherein the control logic comprises a transmit interface configured to dynamically monitor a transmit state for the FWT module and the SWT modules and to assert a conflict signal if the FWT and SWT modules are both transmitting data or preparing to transmit data.

7. The electronic device of claim 6 wherein the transmit interface monitors a physical (PHY) layer or Media Access Control (MAC) layer of the FWT module to determine when the FWT transmits data or prepares to transmit data.

8. A method, comprising:
monitoring a first wireless technology (FWT) module and a second wireless technology (SWT) module;
if the FWT and SWT modules are both operative, disabling any SWT antennas that are less than a threshold distance from any FWT antennas.

9. The method of claim 8 wherein said disabling any SWT antennas comprises triggering a System Service Interface (SSI) request that accesses drivers for SWT antennas that are to be disabled.

10. The method of claim 8 further comprising monitoring a power state of the FWT and SWT modules to determine if the FWT and SWT modules are operative.

11. The method of claim 8 further comprising monitoring a transmit state of the FWT and SWT modules to determine if the FWT and SWT modules are operative.

12. An antenna control module, comprising:
control logic that monitors operations of a first wireless technology (FWT) and a second wireless technology (SWT); and
selection logic that disables a SWT antenna based on said operations and based on whether a distance between said SWT antenna and a FWT antenna is less than a threshold amount.

13. The antenna control module of claim 12 wherein the control logic comprises a power interface to monitor a power state of the FWT and the SWT.

14. The antenna control module of claim 12 wherein the control logic comprises a transmit interface to monitor a transmit state of the FWT and the SWT.

15. The antenna control module of claim 12 wherein the FWT is a Wireless Wide Area Network (WWAN) and the SWT is a Wireless Local Area Network (WLAN).
